(19) United States
(12) Patent Application Publication
(10) Pub. No.: US 2010/0149942 A1
(43) Pub. Date: Jun. 17, 2010

(54) Device for cleaning a spindle support flange of device for reading and/or recording information to and from compact disks

(76) Inventor: Dmitry Anatolievich Belyaev, SAINT PETERSBURG (RU)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/088,928

(22) PCT Filed: Jul. 12, 2007
(86) PCT No.: PCT/RU07/00397

§ 371 Date: Apr. 1, 2008

(30) Foreign Application Priority Data
Apr. 2, 2007 (RU) 2007112076

(51) Int. Cl. G11B 3/58

(52) U.S. Cl. 369/72; G9B/3.084

(57) ABSTRACT

The invention relates to storing information on compact discs and can be used for cleaning a section arranged inside a device for reading information from compact discs, in particular a spindle support pad, on which compact discs are mountable. The aim of the invention is to increase the cluing efficiency of a spindle support pad for a device for reading (recording) information on compact discs. The inventive device for cleaning the support pad (1) of the spindle (2) of a device for reading information from compact discs and/or recording it thereon comprises a cleaning compact disc (4) placeable inside said device on the support pad (1) of the spindle (2) and is provided with a clamp for the cleaning compact disc (4), cleaning elements (6) being positioned on the surface of the cleaning compact disc (4) oriented towards the support pad (1) of the spindle (2). The cleaning elements (6) can be in the form of slots or in the form of brushes.

### TECHNICAL FIELD

This invention is in the field of information storage on compact disks and can be used to clean the inner part inside the compact disc reading device, mainly the spindle support flange—a part on which compact disks are placed.

### BACKGROUND ART

A known device for cleaning optical heads for reading out information from compact disks, comprising a cleaning compact disk with a bulge at the optical head side setting up air current when compact disk rotates, U.S. Pat. No. 5,088,083, IPC G 11 B 3/58, Dec. 16, 1988, wherein air flow blows off dust particles remaining on the optical head after its contact with mechanical cleaning element, insignificant amount of dust is blown away from the inner part of said device wherein the larger part of dust resettles back.

Another known device for reading information from compact-disks that can be used to clean the inner part, comprising a cleaning compact disk placed inside the inner part with a possibility to rotate, said device is provided with an immovable element fixed in the inner part of the reading device being cleaned, that element electrifies and rubs off the surface of the cleaning compact disk wherein the latter rotates, it is also possible to install an element made of dielectric material in the contact zone with the electrifying element on said cleaning compact-disk surface, it is possible to install at least one conducting element on said cleaning compact disk surface, this element contacts with an element made of dielectric material wherein the latter is available, said conducting element can be connected to the casing of said compact disk data reading device, RU 2239883 C1.

Said device enables to collect dust accumulated in the inner part of the compact disk reading device as well as to remove the main parts of dust, at some insignificant degree this device cleans the spindle support flange in said slot

This device is taken as a prototype of the present invention. One of its disadvantages is that prototype device is based on electrostatic method and insufficiently removes foreign matters, dirt from said spindle support surface, which is closed during the cleaning process by cleaning compact disk, which results in misalignment of compact disks, loss of focusing control of a reading lens and failures in the process of data reading (recording).

### SUMMARY OF THE INVENTION

The main task of the present invention is to increase effectiveness of cleaning the spindle support surface of the device for reading (recording) information to/from compact discs.

According to the invention the device for cleaning a spindle support of device for reading and/or recording information to and from compact disks comprises a cleaning compact disk placed on the spindle support in the inner space of the device, wherein a fixing element for cleaning compact disk is provided, in addition there are cleaning elements located on the cleaning disk surface facing the spindle support The cleaning elements can be made in a form of grooves; the cleaning elements can be made in a form of brushes.

The patent applicant has not found any sources containing information on engineering solutions identical to the present invention that makes it possible to refer the invention to the criterion “Novelty” (N).

The device allows cleaning effectively the spindle support flange of device for reading and/or recording information from/to compact disks, based on above said fact a new device feature is obtained preventing compact disks from misalignments as well as from loss of focusing of reading lens, in case of focus loss auto focusing system of reading (recording) devices try to restore the focusing (sometimes it takes a long time, up to 10 minutes), however, if restored, the focusing will be (most probably once again) lost since surging intensity due to compact disks misalignment increases in the process of reading out or recording information from the disk inner circumference toward the outer circumference, as a result of said invention implementation the said negative factors and caused by them failures in the process of reading (recording) information are practically fully eliminated.

The patent applicant has identified no sources containing information on effect of the claimed distinguishing features on the achieved technical result due to their application, according to opinion of the patent applicant this proves conformity of the present technical solution to the criterion “Inventive step” (IS).

### BRIEF DESCRIPTION OF THE DRAWINGS

Further on the invention will be explained by detailed description of its implementation examples with references to the drawings that show the following:

FIG. 1—plan view

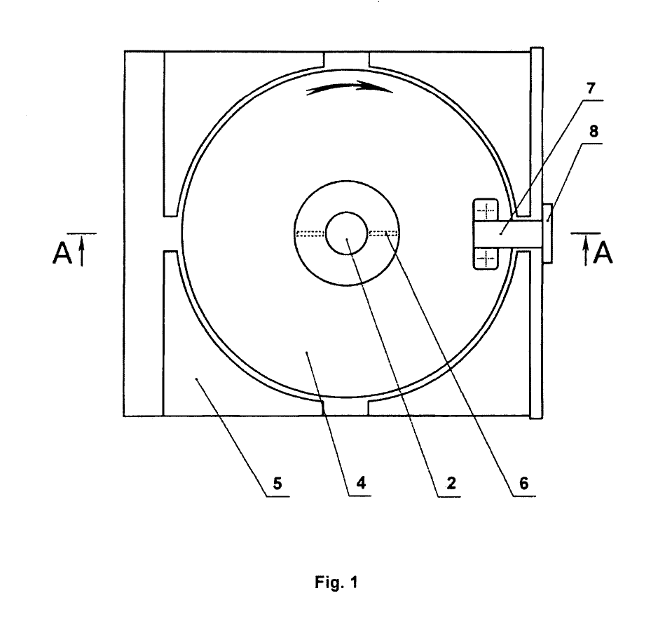

FIG. 2—cross cut A-A in the FIG. 1.

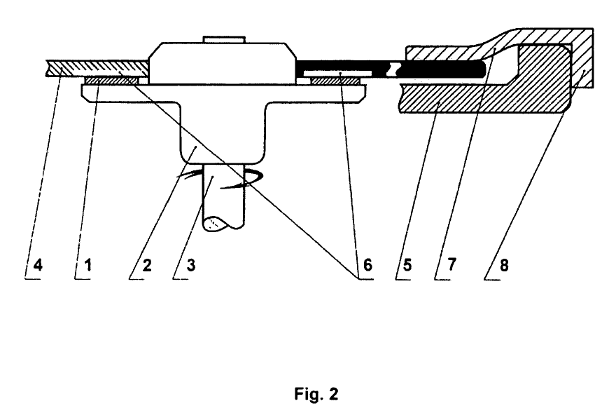

### PREFERRED EMBODIMENTS

Device for cleaning of support assembly 1 of spindle 2 with shaft 3 of the device for reading and/or recording information from/to compact disks comprises a cleaning compact disk 4 placed on support 1 of spindle 2 in the inner part of the device, wherein said spindle 2 comes through a hole in colleting tray 5 of the device for reading and/or recording information, there are cleaning elements 6 located on the cleaning disk surface 4 facing said support 1 of spindle 2, in this example cleaning elements 6 are arranged in the form of grooves, it is also possible to make cleaning elements 6 in the form of brushes, said device is provided with fixing element 7 for the cleaning compact disk, one end of the fixing element is connected to the upper side of compact disk 4, with locking member 8 on the other end.

Said device operates in the following way, said compact disk 4 is placed in the collecting tray 5, tray 5 is pushed back into the compact disk reading devise spindle 2 is lifted up and compact disk 4 gets to the support flange, then shaft 3 starts rotating wherein said compact disk 4 remains immovable due to fixing element 7, its locking member 8 thrusts against the external surface of collecting tray 5, said support 1 of spindle 2 rotates around the immovable compact disk 4, cleaning elements 6 of compact disk 4 (grooves) collect and accumulate dust and foreign matters from the surface of the spindle support 1, then the compact disk 4 is ejected and the dust and foreign matters accumulated in the grooves can be removed, after this the cleaning disk is ready for next use.

The claimed device is most effective for application in devices for recording information on compact disks because in case of failures caused by focus loss in the process of recording a recorded compact disk will be fully disabled.

Said device can be applied for the most currently used devices for reading out and/or recording information on compact disks supporting the formats CD, CD ROM, DVD, HD DVD, Blue Ray and etc.

### INDUSTRIAL APPLICABILITY

Known simple industrial equipment and constructive materials common in the art are used for the production of said device, which, in applicant's opinion, enables to conclude that said inventive device conforms to the criterion “Industrial Applicability” (IA).

1. A device for cleaning a spindle support of device for reading and/or recording information to and from compact disks comprises a cleaning compact disk placed on the spindle support in the inner space of the device, wherein a fixing element for cleaning compact disk is provided, in addition there are cleaning elements located on the cleaning disk surface facing the spindle support.

2. A device of claim 1, wherein cleaning elements are made in the form of grooves.

3. A device of claim 1, wherein cleaning elements are made in the form of brushes.
